(19) United States
(12) Patent Application Publication
(10) Pub. No.: US 2014/0142994 A1
(43) Pub. Date: May 22, 2014

(54) FRIENDS' EVENTS

(71) Applicant: Vendini, Inc., San Francisco, CA (US)

(72) Inventors: Marco Matarazzi, Gualdo Tadino (IT); Andrea Sprega, Gualdo Tadino (IT)

(73) Assignee: Vendini, Inc., San Francisco, CA (US)

(21) Appl. No.: 14/050,200

(22) Filed: Oct. 9, 2013

Related U.S. Application Data
(60) Provisional application No. 61/711,639, filed on Oct. 9, 2012.

(51) Int. Cl. G06Q 10/02; G06Q 50/00

(52) U.S. Cl. CPC G06Q 10/02; G06Q 50/01
USPC 705/5

(57) ABSTRACT

A method prompts a user to create a user account on a ticketing application. The application connects the user to a social media application to locate friends who have created accounts on the social media application and the ticketing application, The social media application exports data to the ticketing application in the form of a list of friends. The user selects a friend from the list, views events the user is attending, selects an event, and views details about the event. If the user wishes to attend the same event, the user purchases a ticket.

### RELATED APPLICATIONS

The present application claims priority to U.S. provisional application number 61/711,639, filed Oct. 9, 2012, the disclosure of which is incorporated by reference.

### BACKGROUND

1. Field of the Invention

The present invention generally concerns event ticket purchasing and processing. More particularly, the present invention relates to using a ticketing application to view and purchase tickets to events that friends are attending.

2. Description of the Related Art

Traditionally, a paper ticket is issued and sold for each available seat at a live event or performance such as a concert, movie, ballet, or sporting event. A party wishing to attend the event is usually tasked with finding an available ticket, purchasing the ticket, receiving the purchased ticket (i.e., via e-mail, mail, or will call), and presenting the ticket to gain entry into the event. A problem may arise when a party wants to know whether any of the party's friends are attending an event before purchasing a ticket. If the party were able to ascertain whether a friend is attending a specific event, the party may then wish to attend the same event, preferably by purchasing a ticket for a seat near the friend's seat. Therefore, there is a need for a method and system for using a ticketing application to view which events a party's friends are attending and purchase tickets for seats that are nearby the friend's seat.

### SUMMARY OF THE CLAIMED INVENTION

A user creates a user account with a mobile application. Then the user connects to a social media application to find friends who have accounts on both the social media application and the ticketing application. In doing so, the social networking application generates and exports a list of the friends of the user to the ticketing application. The user can then see the list of friends, and choose one of those friends to see which events the friend is attending. The user selects one of the events to see details about the event (e.g., type of event, date and time, location) and, if the user wants to attend the event, purchases a ticket to the event for himself.

In a further embodiment, a user creates a user account on a ticketing application and then searches for friends who have created profiles on the ticketing application. The viewer can see a list of events that the friend is attending and choose an event to view more information about the event. If the user wants to attend the event, the user can purchase a ticket to the event for himself.

### BRIEF DESCRIPTION OF THE FIGURES

FIG. 1 illustrates using a computer-implemented ticketing application to view and purchase tickets to events that friends are attending;

FIG. 2A illustrates an exemplary graphical interface for prompting a user to create a user account;

FIG. 2B illustrates an exemplary graphical interface for displaying a list of friends associated with the user through the ticketing application or at least one social networking application;

FIG. 2C illustrates an exemplary graphical interface for displaying a list of events associated with a friend;

FIG. 3 illustrates a computing system that may be used to implement the method of the present invention.

### DETAILED DESCRIPTION

Embodiments of the present invention provide a system and method for viewing events that other users are attending and purchasing electronic tickets to the same event, and may be used in conjunction with any ticket transfer system or method.

One or more tickets to an event may be electronically purchased by a user associated with a computing device. The purchased tickets may be digital, e-tickets, or print-at-home tickets (e.g., PDF, HTML, etc.). The event may be any private or public prerecorded, repeat, or live event or performance known in the art such as a concert, sporting event, show, movie, or musical recital. A purchased ticket may be electronically received by the user from the ticket seller or source and saved to a database accessible by the computing device. The user may choose to load or import on or more received tickets into an application for hosting electronic tickets and accessible by the computing device.

The steps of the method of the present invention may be embodied in hardware or software including a non-transitory computer-readable storage medium (e.g., an optical disc or memory card) having instructions executable by a processor of a computing device. A user may launch or activate the method by opening or activating an application (e.g., a ticketing application) in a computing device such as a mobile device. A ticketing application may be implemented by one or more processors that execute instructions stored in memory mediums. The executed code may result in the processor(s) generating one or more graphical interfaces.

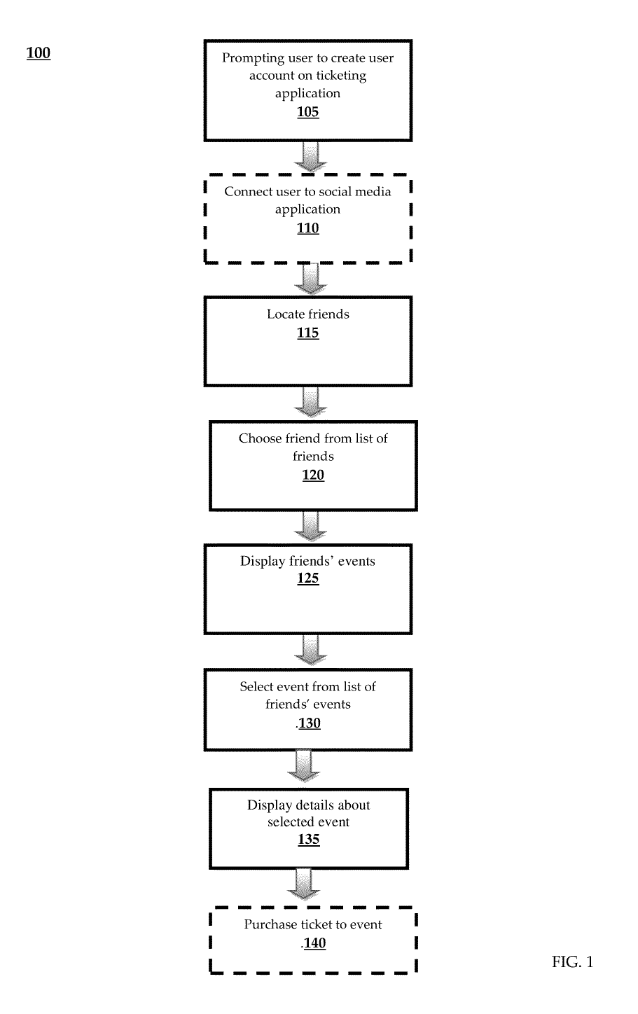

According to the present invention, a user may use the ticketing application to locate friends. FIG. 1 illustrates a computer-implemented method 100 for locating events associated with friends. A user may be prompted to create a user account on a ticketing application at step 105. The user may then be connected to one or more social media applications over a communications network via the ticketing application, at optional step 110. At step 115, the social media application may locate one or more friends who have created accounts on the social media application and the ticketing application. The social media application then generates and exports data to the ticketing application in the form of a list of friends. The user may be required to request and receive permission to view the profile of the friend.

Alternatively, at step 115, the user may search for friends who have created accounts on the ticketing application by entering search criteria (e.g., name, email address) in the ticketing application. The user may then “connect” with the friend by selecting a friend from the friends list and, if required, requesting permission to view the profile of the friend.

At step 120, the user may be prompted to select a friend from the list of friends or from the search results in the ticketing application. At step 125, the ticketing application may then display a list of events for which the friend has already purchased one or more tickets.

At step 130, the user may select an event of interest. Details about the event and the ticket purchased, including, for example, event name, time, and location, seat number and location, and ticket price , may be displayed for the user to view in the ticketing application, at step 135.

At step 140, the user may wish to purchase one or more tickets to the event. If the ticketing application is selling tickets directly for the selected event, the user may purchase a ticket to the same event through the ticketing application. In an exemplary embodiment, the user may be able to view available tickets for the selected event. The user may also select and electronically purchase a ticket for a seat or location that is nearest to the friend's reserved seat or location by viewing, for example, a map of the venue showing available tickets and indicating the friend's reserved seat or location.

Once a user has purchased a ticket through the ticketing application, the user may “share” that it is attending a selected event by posting information, such as the event name, location, date, and time, via various social media applications. That the user has purchased a ticket may also appear on the user's ticketing application profile so that other users who have permission to view the user's profile may see that the user is attending the event and purchase tickets if desired.

If the ticketing application is not selling the tickets directly for the selected event, the user may be re-directed to another available seller, re-seller, vendor or other source, where the user may purchase tickets for the selected event. The seller, re-seller, vendor, or other source may or may not allow the user to view and purchase tickets for seats nearest the friend's reserved seat or location.

The user may upload an electronic ticket purchased from an outside source into the ticketing application. The purchased ticket may appear in the ticketing application user profile so that other users who have permission to view the user's profile may see that the user is attending the event.

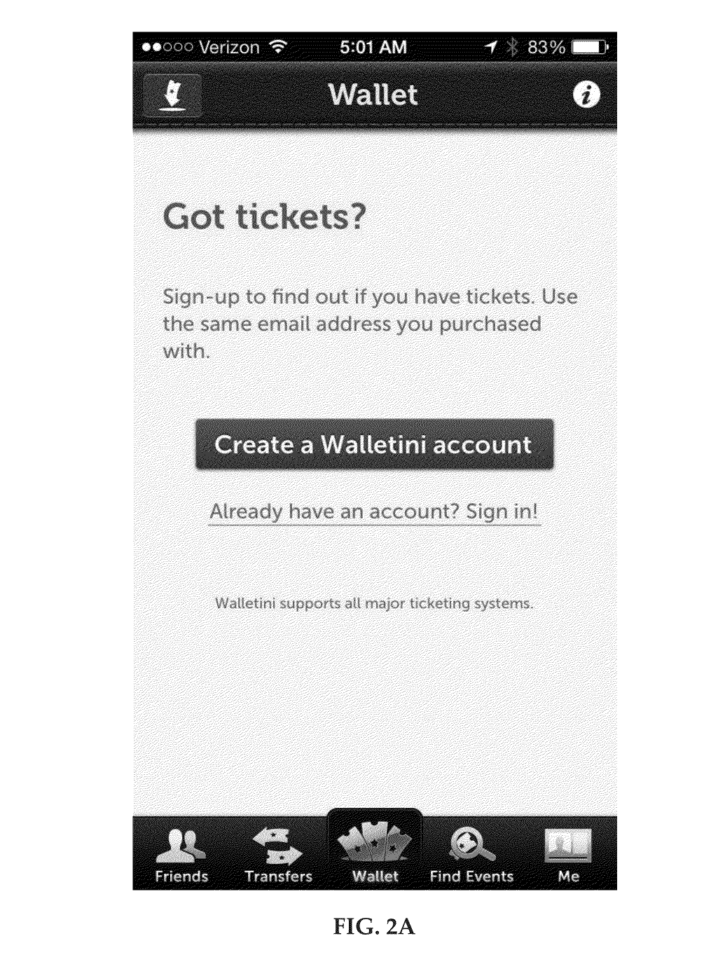

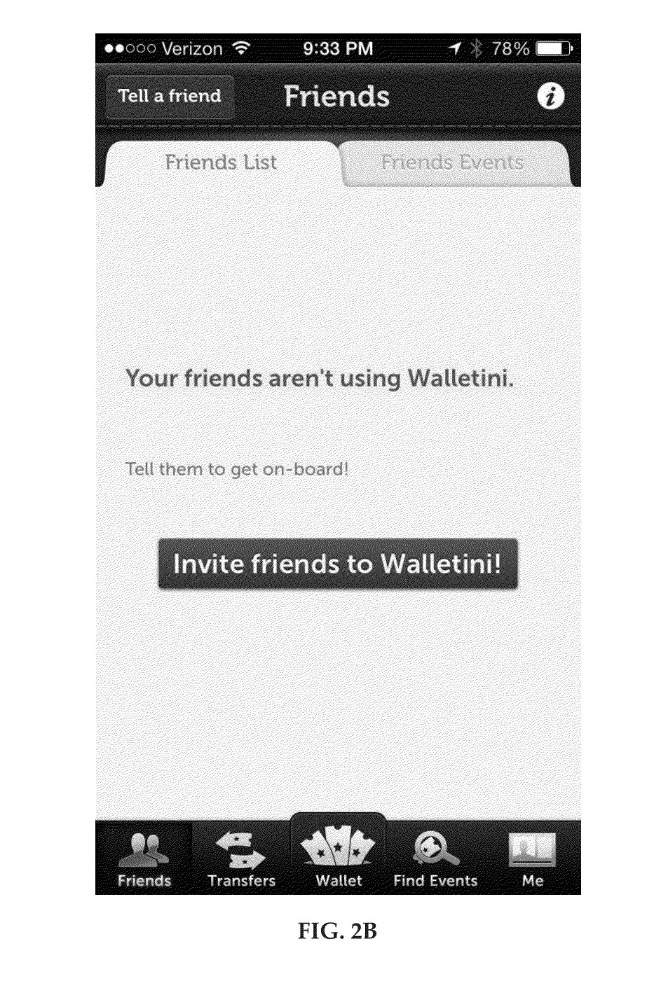

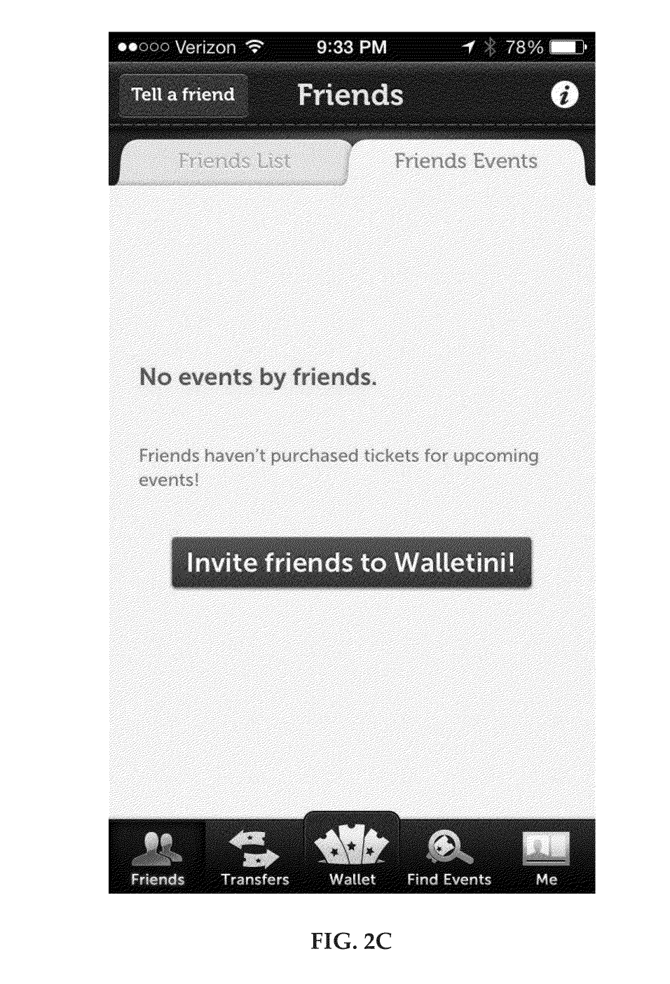

FIGS. 2A-2C illustrate exemplary interfaces for gathering market data, as described in step 100 of FIG. 1.

FIG. 2A illustrates an exemplary graphical interface for prompting a user to create a user account, as described in step 105 of FIG. 1. The user may press a “Create Account” or similar button to register a user account. Alternatively, if the user has already registered, she may bypass this procedure by logging into the ticketing application using her secure credentials, such as a user name and password.

FIG. 2B illustrates an exemplary graphical interface for displaying a list of friends associated with the user through the ticketing application or at least one social networking application, as described in step 115 of FIG. 1. The user may also send notices to friends via the social media applications to invite them to create an account and profile with the ticketing application.

FIG. 2C illustrates an exemplary graphical interface for displaying a list of events associated with a friend, as described in step 125 of FIG. 1.

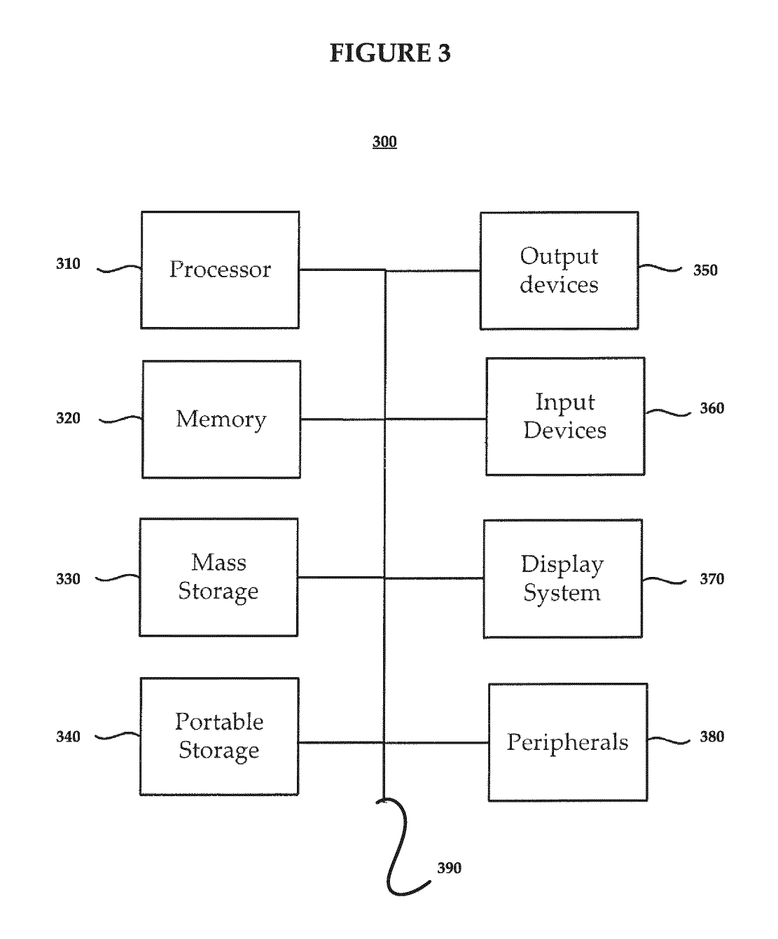

FIG. 3 illustrates a computing system 300 that may be used to implement an embodiment of the present invention. System 300 of FIG. 3 may be used to implement a computing device, network server, application server 150, and/or database operating in the context of the method of FIG. 1. The computing system 300 of FIG. 3 includes one or more processors 310 and memory 320. Main memory 320 stores, in part, instructions and data for execution by processor 310. Main memory 320 can store the executable code when in operation. The system 300 of FIG. 3 further includes a mass storage device 330, portable storage medium drive(s) 340, output devices 350, user input devices 360, a graphics display 370, and peripheral devices 380.

The components shown in FIG. 3 are depicted as being connected via a single bus 390. The components, however, may be connected through one or more data transport means. For example, processor unit 310 and main memory 320 may be connected via a local microprocessor bus, and the mass storage device 330, peripheral device(s) 380, portable storage device 340, and display system 370 may be connected via one or more input/output (I/O) buses.

Mass storage device 330, which may be implemented with a magnetic disk drive or an optical disk drive, is a non-volatile storage device for storing data and instructions for use by processor unit 310. Mass storage device 330 may store the system software for implementing embodiments of the present invention for purposes of loading software into main memory 320.

Portable storage device 340 operates in conjunction with a portable nonvolatile storage medium, such as a floppy disk, compact disk or Digital video disc, to input and output data and code to and from the computer system 300 of FIG. 3. The system software for implementing embodiments of the present invention may be stored on such a portable medium and input to the computer system 300 via the portable storage device 340.

Input devices 360 provide a portion of a user interface. Input devices 360 may include an alpha-numeric keypad, such as a keyboard, for inputting alpha-numeric and other information, or a pointing device, such as a mouse, a trackball, stylus, or cursor direction keys. Additionally, the system 300 as shown in FIG. 3 includes output devices 350. Examples of suitable output devices include speakers, printers, network interfaces, and monitors.

Display system 370 may include a liquid crystal display (LCD) or other suitable display device. Display system 370 may receive textual and graphical information, and process the information for output to the display device.

Peripherals 380 may include any type of computer support device to add additional functionality to the computer system. For example, peripheral device(s) 380 may include a modem or a router.

The components contained in the computing system 300 of FIG. 3 are those typically found in computer systems that may be suitable for use with embodiments of the present invention and are intended to represent a broad category of such computer components that are well known in the art. Thus, the computing system 300 of FIG. 3 may be a personal computer, hand held computing device, tablet device, telephone, mobile computing device, workstation, server, minicomputer, mainframe computer, or any other computing device. The computer may also include different bus configurations, networked platforms, multi-processor platforms, etc. Various operating systems may be used including Unix, Linux, Windows Mobile, or iOS. The steps of the method of FIG. 1 (and its various alternatives) may be performed by a module or engine stored on a computer readable storage medium (e.g., optical disc, memory card, etc.) comprising instructions executable by a processor of a computing device.

The above description is illustrative and not restrictive. Many variations of the invention will become apparent to those of skill in the art upon review of this disclosure. While the present invention has been described in connection with a variety of embodiments, these descriptions are not intended to limit the scope of the invention to the particular forms set forth herein. To the contrary, the present descriptions are intended to cover alternatives, modifications, and equivalents as may be included within the spirit and scope of the invention as defined by the appended claim and otherwise appreciated by one of ordinary skill in the art.

What is claimed is:

1. A computer-implemented method for viewing events associated with social networking friends and purchasing similar tickets, the method comprising:
prompting a user to create a user account on a ticketing application;
connecting the user to one or more social media applications over a communications network via the ticketing application, wherein the social media application locates one or more friends who have created accounts on the social media application and the ticketing application, and wherein the social media application exports data to the ticketing application in the form of a list of friends;
prompting the user to select a friend from the list of friends;
displaying a list of events for which the friend has purchased at least one ticket;
prompting the user to select an event from the list of events;
displaying details about the event and the at least one ticket; and
prompting the user to purchase a new ticket for the event.

2. The method of claim 1, further comprising sending a notice to the friend via the one or more social media application with an invitation to create an account with the ticketing application.

3. The method of claim 1, wherein the locating the one or more friends includes a manual search by the user for friends that have created profiles with the ticketing application.

4. The method of claim 3, wherein the manual search includes entering search criteria.

5. The method of claim 4, wherein the search criteria includes at least an email address.

6. The method of claim 4, wherein the search criteria includes at least a partial name.

7. The method of claim 1, further comprising requesting permission to view the profile of the friend on the social networking application where the profile is not viewable by the public.

8. The method of claim 1, wherein the details about the event include at least an event name.

9. The method of claim 1, wherein the details about the event include at least an event date and time.

10. The method of claim 1, wherein the details about the event include at least a location.

11. The method of claim 1, wherein the details about the event include seat information.

12. The method of claim 11, wherein the seat information includes seat number and location within a venue.

13. The method of claim 1, wherein the details about the event include at least a ticket price.

14. The method of claim 1, wherein the new ticket is purchased directly through the ticketing application.

15. The method of claim 1, wherein the new ticket is purchased through a third party ticket vendor.

16. The method of claim 11, wherein the new ticket is purchased based at least in part on the seat information.

17. The method of claim 1, further comprising posting information regarding the new ticket to the profile of a user on at least one social media application.

18. A computer-implemented method for viewing events associated with social networking friends and purchasing similar tickets, the method comprising:
prompting a user to create a user account on a ticketing application;
allowing the user to search for a friend who has created a user profile on the ticketing application by entering identifying information about the friend;
displaying a list of events for which the friend has purchased at least one ticket;
prompting the user to select an event from the list of events;
displaying details about the event and the at least one ticket; and
prompting the user to purchase a new ticket for the event.
